(19) United States
(12) Patent Application Publication
(10) Pub. No.: US 2020/0406567 A1
(43) Pub. Date: Dec. 31, 2020

(54) ELECTRIC PRESS WITH TORQUE MOTOR

(71) Applicant: ARCOFIL S.A., St-Imier (CH)

(72) Inventors: Yves BEAUMANN, La Chaux-de-Fonds (CH); Michael DEUBEL, Péry (CH)

(21) Appl. No.: 16/976,854

(22) PCT Filed: Mar. 4, 2019
(86) PCT No.: PCT/EP2019/055250

§ 371 Date: Aug. 31, 2020

(30) Foreign Application Priority Data
Mar. 5, 2018 (EP) 18159893.9

(51) Int. Cl. B30B 15/04; B30B 15/00; B30B 1/26; B30B 15/14; B30B 1/28

(52) U.S. Cl. CPC B30B 15/041; B30B 15/0029; B30B 1/28; B30B 15/14; B30B 1/266

(57) ABSTRACT

An electromechanical press includes: a work table defining an upper horizontal working plane P1 on which samples are arranged; a device for forming workpieces including a forming tool arranged to be movable in translation in a vertical plane P2 perpendicular and secant to P1; and an electromechanical actuating device actuating the forming device, supported on a frame fixed relative to P1, the electromechanical actuating device in kinematic connection with the forming device. The electromechanical actuating device includes at least one Torque-type electric motor with an eccentric axis in kinematic connection with the forming device, the electromechanical actuating device supported on the frame in a position intersecting P2 of movement of the forming device and located between a base of the frame on the floor and the work table under P1, the forming tool held in any position in or above P1, the work table being integral with the frame.

### TECHNICAL FIELD

The present invention relates to the field of machining machines and concerns more particularly an electromechanical press with a Torque motor.

### STATE OF THE ART

Many variants of hydraulic, pneumatic and mechanical presses have long been known in the field of forming and shaping of materials, especially metals. These presses differ in particular by their power, expressed in tons (T), their productivity, their versatility of tooling and applications (stamping, cutting, stamping, etc.). The great majority of mechanical presses are based on the use of an actuating device of the crank rod type, which moves a tool back and forth in a controlled rhythm from top to bottom in a linear fashion towards a work surface located under the tool and the actuating device of the latter. Moreover, almost all existing hydraulic, pneumatic and mechanical presses have a motor/actuator assembly located at a height above the work surface, which requires significant installation dimensions, safety and anchoring constraints, not to mention the difficulties and costs of implementation and maintenance and service of these installations.

For small series of parts with small dimensions (millimetres or centimetres), which do not require high tool striking power, electromechanical presses with jacks have been proposed. These presses provide greater ease of use, easy tool changes and can be automated by numerical control, making them more versatile in general. However, their vertical dimensions, linked to the size of the jacks, generally remain very large (1 m or more). In addition, their strike rates remain limited.

There is therefore a need to provide compact press technology that can be controlled by numerical control and in combination with automatic tool change machines to provide great versatility of use while also providing an operating rate similar to known mechanical presses.

In addition to the size and ease of use of electromechanical presses, it is also necessary to ensure perfect safety for users whatever their operating regime, as well as great flexibility and reactivity in setting and operation, whether during striking cycles or in the event of sudden stops.

The purpose of the present invention is to provide an electromechanical press meeting these needs.

### DISCLOSURE OF THE INVENTION

According to a first aspect, the invention relates to an electromechanical press as defined in claim 1. More particularly, the press of the invention is dedicated to the forming of parts by deformation and/or cutting of material from a sample, and comprises:
a work table defining, in an orthonormal marker XYZ, a work plane P1, coinciding with the XZ plane of the marker, on which one or more samples to be formed can be arranged at one or more predetermined positions, and
a device for forming workpieces by deforming and/or cutting material from said samples arranged on the working plane of said table, the device for forming workpieces comprising a forming tool arranged so as to be movable in translation in a plane P2 perpendicular and secant to the working plane P1 of the table, and
an electromechanical actuating device for actuating the forming device, supported on a frame which is fixed in position relative to the working plane P1, the electromechanical actuating device being arranged in kinematic connection with the forming device in order to move said forming tool back and forth over a given stroke in the plane P2,

The press of the invention is characterised by the fact that the electromechanical actuating device comprises at least one Torque-type electric motor with an eccentric axis arranged in kinematic connection with the forming device, the electromechanical actuating device being supported on the frame in a position intersecting the plane P2 of movement of the forming device and located between a base of the frame on the floor and the work table under the work plane P1, while the forming tool is held in any position in or above the work plane P1 of the work table, the work table being integral with the frame.

The press of the invention thus presents a more compact and stable structure due to the integrated, substantially central arrangement of the actuating device and more particularly of its Torque motor under the work table and in the plane of movement of the working tool.

In addition, the use of the Torque motor gives the press of the invention an unparalleled versatility and flexibility of operation. The use of a torque motor allows a direct drive of the forming device, without gearboxes, with high torque and high reactivity. In addition, it has other advantages which are described in more detail below.

Preferably according to the invention, the frame comprises partition walls fixed integrally to the work table and the anchoring base in such a way that the electromechanical actuating device is fitted to the frame. These partition walls allow the frame to be made considerably stiffer and heavier, thus increasing the resonance frequency of the press, avoiding the press moving and jumping during operation and significantly increasing its K safety factor. Thus, for the press of the invention, lateral displacements on the floor were measured to be less than 0.01 mm and a maximum Von Mise stress (safety factor) of K=1000.

The partition walls are also advantageously equipped with an internal sound-insulating lining to absorb the operating noise of the actuating device and also at least partially the vibrations of the frame.

Depending on the embodiment, the electromechanical actuating device has at least one connecting rod rotatably mounted at a first end on the eccentric shaft of the Torque motor and at a second end on the forming device.

In a special embodiment, the electric motor of the Torque-type is provided with two opposite eccentric shafts each connected to a connecting rod rotatably mounted at a first end on said eccentric shaft of the Torque motor and at a second end on the forming device.

With further advantage, the forming device is mounted so that it can be moved translationally in the plane P2 on said work table.

Preferably, the forming device comprises a gantry sliding on said table, said gantry comprising a cross-member for mounting the forming tool integral at its respective ends with a first end of a link arm mounted at a second end to a said connecting rod of the electromechanical actuating device.

The press is advantageously designed with translation guides, especially of the slide type, for the forming device in the plane P2 on the work table.

In particular, the translation guide members are arranged on the arms of the sliding gantry on the one hand and in lateral guide openings of said arms formed for this purpose in the table symmetrically to the plane P2.

Advantageously still, the press of the invention comprises means for moving and dynamically adjusting the distance from the movable crosshead to the work table in the P2 plane. These means of movement and adjustment may include a trapezoidal screw for adjusting the bottom dead centre of the forming tool mounted on the crosshead. In addition, this allows compensation for expansion during the day and wear of the tools.

An advantageous feature of the invention is that the actuating device is arranged to be movable in translation along the Y axis relative to the work table on the frame. In particular, the actuating device is slidably mounted on the frame by means of complementary linear guide members fixed on the actuating device and the frame and kinematically connected to a motor unit for linear displacement in translation along the Y axis relative to the work table.

This sliding mounting of the press drive is particularly advantageous to offer great versatility and ease of press adjustment. By moving the actuating device, it is not only the actuating device but also the forming device kinematically linked to it at the level of the connecting rods which is mobilised along the Y axis, and which is therefore adjusted in position relative to the work table, which defines the reference plane P1 of the press.

As a special example, the engine assembly may include a hydraulic piston or flywheel piston integral with a worm gear.

The electromechanical press of the invention furthermore preferably comprises a numerical control device for the actuating device. This numerical control device is configured in particular to regulate in real time the operation of the Torque motor of the actuating device, in particular to ensure the correct striking rate of the forming tool, for example. Advantageously, the numerical control device is also configured to drive the linear motion motor assembly of the actuator. It is thus possible to change the configuration of the press to switch from one series to another in an automatic way, an operator or a robotised assembly associated with the press having then only to change the forming tool on the forming device in masked time during the adjustment.

The press of the invention can also offer an even more scalable configuration by the possibility offered to vary its power by combining in the actuating device a plurality of Torque-type electric motors mounted electrically in series and kinematically coupled to each other at their respective drive shafts.

### BRIEF DESCRIPTION OF THE DRAWINGS

The specific characteristics and details of the press according of the invention will become clearer on reading the following description, with reference to the attached drawings in which:

FIG. 1 represents a perspective view of an electromechanical press according to a preferred embodiment of the invention;

FIG. 2 is a cross-section view according to a median sagittal P2 plane of the press shown in FIG. 1;

FIG. 3 is a cross-section view according to a median transverse P3 plane of the press shown in FIG. 1;

FIG. 4 is a view similar to FIG. 1 of an alternative embodiment for the second preferred embodiment;

FIG. 5 is a view similar to FIG. 2 of the press of the invention according to the second embodiment of FIG. 4.

### DESCRIPTION OF AN EMBODIMENT OF THE INVENTION

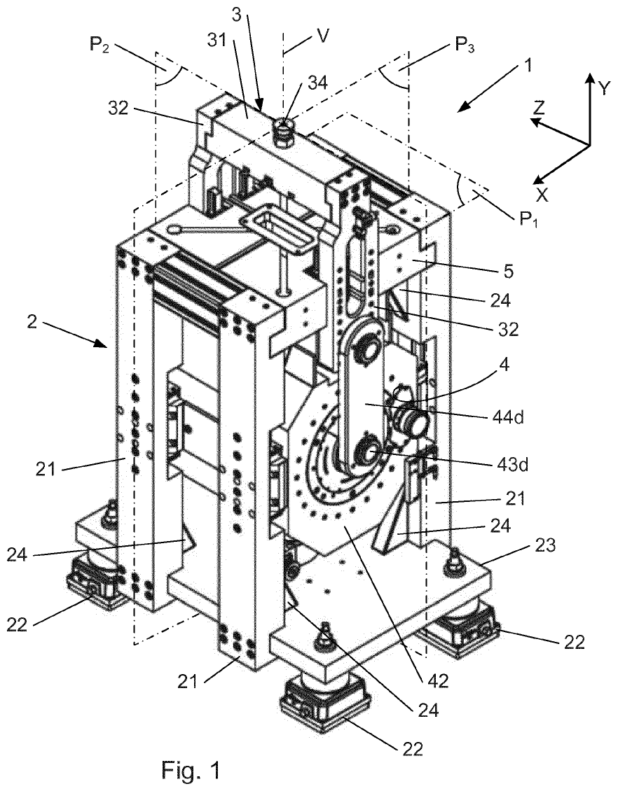

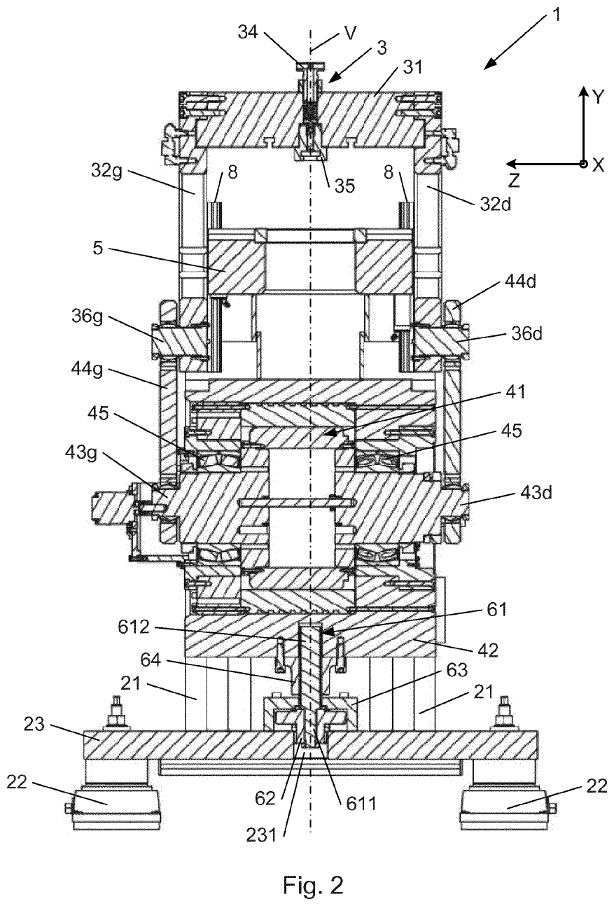

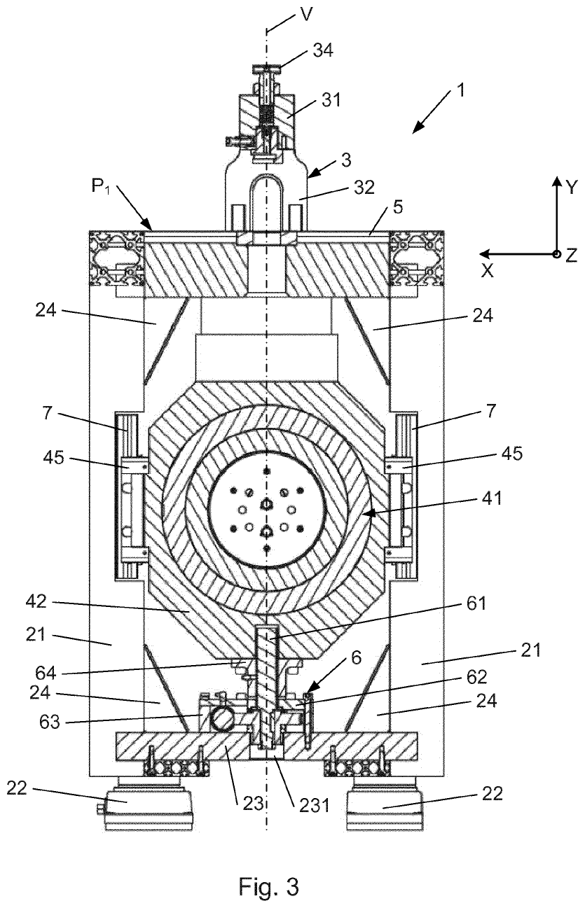

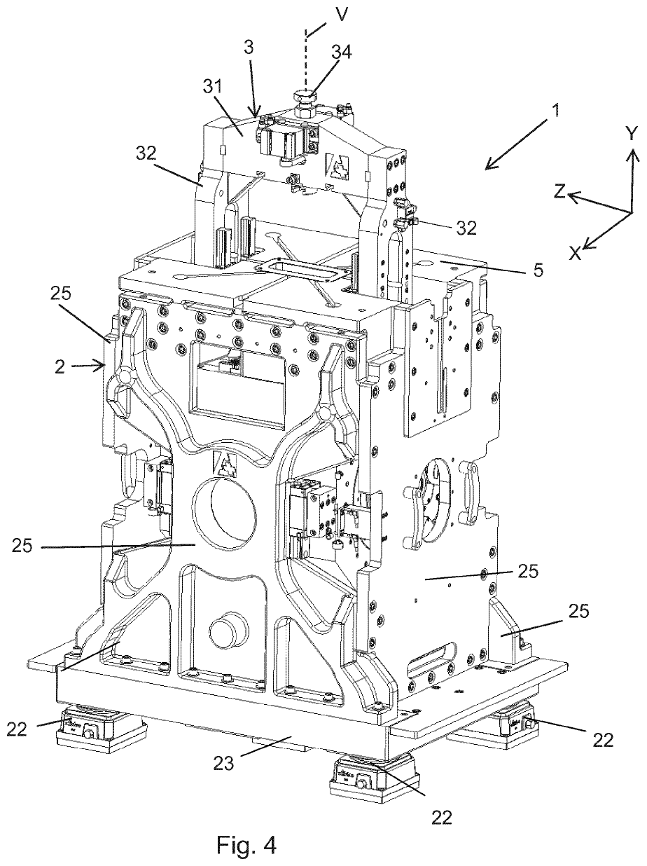

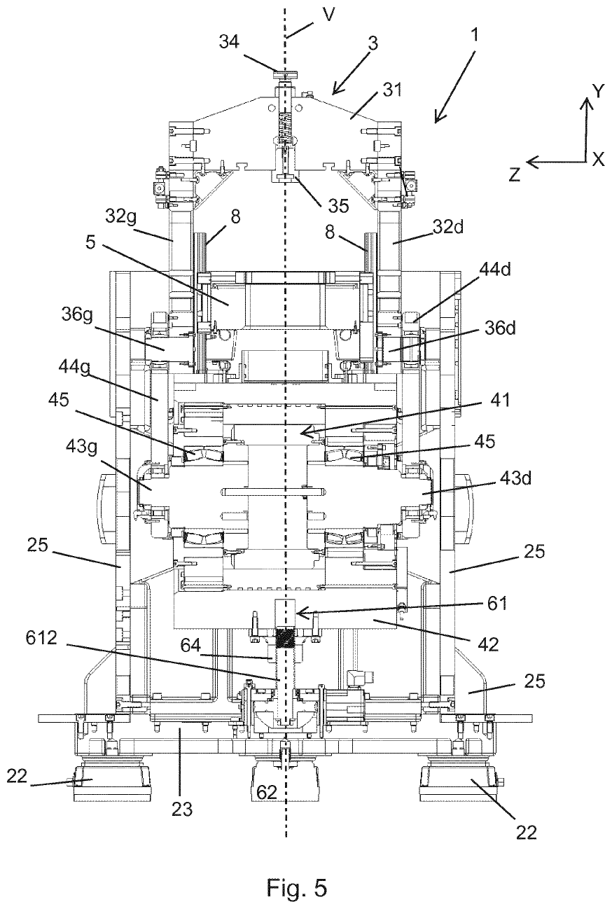

The present invention relates to an electromechanical press 1 for forming workpieces by deforming and/or cutting material from a sample, represented in a first preferred embodiment in FIGS. 1 to 3 and in FIGS. 4 and 5 in a second preferred embodiment.

In both of the two embodiments shown, press 1 firstly comprises a frame 2 on which an electromechanical actuating device 4 of a workpiece forming device 3 is mounted in a translational reciprocating motion in a vertical plane P2 of press 1. The forming device 3 is arranged in kinematic connection in the form described below with the actuating device 4 in such a way that a forming tool 35 attached to the forming device 3 is moved back and forth to and from a work table 5, which is fixed to the frame 2 and stationary on the latter. The forming tool 35 can be of various types depending on the forming operation to be carried out, such as cutting, stamping or reworking for example.

Work table 5 defines an upper horizontal working plane P1 in an orthonormal marker XYZ, which coincides with the XZ plane of the marker, on which one or more samples to be formed by impact of the forming tool 35 can be arranged at one or more defined positions in the conventional manner for a press. Preferably, work table 5 has an opening in the middle of work tool 35 to provide space for the stamping chips to be removed with each stroke of the forming tool. The vertical plane P2 in which the forming device 3 is moved is perpendicular and secant to the working plane P1 of table 5.

Frame 2 consists of a weighted base plate 23 made of metal or concrete, under which adjustable feet 22 are fixed. In the first embodiment of FIGS. 1 to 3, four pillars 21 made of e.g. steel beams are anchored to the base plate by any appropriate means such as bolting and/or welding and/or embedding. These pillars 21 support at their upper end the work table 5, which is firmly anchored to the pillars 21. In an alternative embodiment not shown, frame 2 and work table 5 can be formed into a one-piece, typically metallic.

In order to stabilise the pillars 21 on the base plate and the table 5 on the pillars 21 reinforcement brackets 24 are attached to the corners between each of the pillars 21 and the plate 23 on the one hand and the pillars 21 and the table 5 on the other hand. This results in a rigid and stable frame 2 on which the electromechanical actuating device 4 is installed and in relation to which the forming device 3 is moved by the latter as described below.

In the embodiment of FIGS. 4 and 5, the pillars 21 are replaced by four partitioning and stiffening walls 25 preferably made of steel or aluminium alloy forging, these walls 25 being anchored to the base 23 and to the work table 5 by any appropriate means such as bolting and/or welding and/or embedding. The walls 25 allow the electromechanical actuating device 4 to be fully encased on frame 2 and increase the rigidity of the latter compared to the method used in FIGS. 1 to 3. In fact, the walls 25 are shaped to be recessed on their longitudinal edges, which makes it possible to eliminate or at least considerably reduce any effects of torsion of the worktable 5 in relation to the base 23 during the operating cycles of press 1, and also to reduce vibrations considerably.

Moreover, this second embodiment with partition walls and stiffening 25 allows advantageously to double the natural frequency of resonance of the press compared to the embodiment of FIGS. 1 to 3, while reducing the movements on the ground during operation by a factor higher than 10. Finally, the safety factor K of the press, qualified by the Von Mise constraint, is maximised at a considerable value of Kmax=1000.

The walls 25 are additionally coated with a sound-insulating and vibration-absorbing facing layer in the form of a sandwich or integrated into a metal sheet structure. Such cladding can be made of any suitable fireproof insulation, notably based on natural and/or synthetic compacted fibres or thermoformed synthetic foams. The safety and comfort of operators on production sites is thus improved by increased absorption of noise pollution during press operation.

Of course, another non-represented embodiment can be considered, which is a pure combination of the two methods of construction of FIGS. 1 to 3 and 4 to 5, for example by attaching partition walls 25 to pillars 21, table 5 and base 23 of press 1 of FIGS. 1 to 3.

According to the invention, the electromechanical actuating device 4 is advantageously mounted on the frame 2 in an intermediate position between the base plate 23 and the table 5, i.e. in a central position in the plane of movement of the forming device 3 and ideally on the V-axis of the forming tool, located below the working plane P1. In addition, the forming device 3 is coupled to the actuating device in such a way that the forming tool 35 is held in any position in or above the work surface P1 of work table 5.

More specifically, the electromechanical actuating device 4 comprises a Torque-type electric motor 41, mounted as a single unit and movable in translation along the pillars 21 of the frame 2 by means of a carriage 45 on rails or slides 7 fixed in internal recesses of the pillars 21. Carriage 45 and guideways 7 thus form complementary linear guiding elements of the actuator 4 on frame 2. The electromechanical actuating device 4 is also arranged in kinematic connection with a motor assembly 6 for linear translational movement along a central vertical axis V contained in plane P2 with respect to the work table 5. The electromechanical actuator 4 is thus height-adjustable in plane P2. The motor unit 6 is advantageously arranged on plate 23 of the base plate of the frame 2 and fixed to the latter by any suitable means, as well as to the motor housing 42 of the motor 41 of the actuator 4.

In a special embodiment shown in FIGS. 1 to 3, the motor assembly 6 has a setscrew 61 mounted freely rotatably in the V-axis on plate 23 in a central hole in the plate. The worm screw 61 has a lower section 611 forming a drive shaft integral with a motor flywheel 62 mounted coaxially on the drive shaft. The worm screw 61 also has an upper threaded section 612 extending in the extension of the lower section 611 along the V axis through a bell 63 for plating the flywheel 62 in hole 231 of plate 23 to prevent any translation of the screw 61 along the V axis, and into a blind bore along the V axis with an internal diameter substantially equal to the external diameter of the threaded section of the screw 61. In order to allow the displacement of the motor assembly 4 in the plane P2 by the screw 61 according to its direction of rotation, the screw 61 is coupled to the motor by its threaded portion via a nut 64 fixed on the housing 42 of the motor 41 coaxially to said blind bore. Thus, a rotation of the handwheel 62 in one direction causes the screw 61 to rotate in the same direction on itself, which by the effect of engagement in the nut 64 induces a vertical translation of the actuating device 4 guided by its carriage 45 on the guides 7 of the frame 2 upwards or downwards. Turning the handwheel 62 in the opposite direction will result in a vertical movement of the actuator 4 in the opposite direction.

The flywheel 62 can be advantageously controlled by a mechanical, electronic and/or hydraulic drive system, according to standard techniques in the field of industrial automation. Preferably, this actuation is electro-controlled by central numerical control of the entire press and electric motor 41 as described in more detail below.

The electric motor 41 of the electromechanical actuator is preferably a Torque-type motor. Such a motor has the advantage that it can be driven and controlled essentially by an electronic setpoint signal in a substantially instantaneous manner, i.e. without inertia. This means that a desired operating speed can be reached very quickly, or the rotation of the motor and thus the associated forming device 3 can be stopped instantly. It is also possible to adjust the engine control setpoint to optimize the electronic consumption of the engine. This means that the operating control of the motor can be adjusted to the particular kinematics of the forming device 3 as required.

In addition, this type of motor is fully electronically controllable, if necessary with speed and power/torque variations during the cycle depending on the workpieces being processed.

In addition, it provides extreme operational safety with very short stopping angles in the range of ˜10°-20° at a forming tool stroke rate of 500 strokes/min, where a mechanical press with a handwheel and brakes has a stopping angle in the range of ˜120°-150° at 350 strokes/min.

Finally, the Torque motor allows the forming device to vibrate during the cycle, if necessary with adjustable pitch, to improve the surface finish of stamped parts for example. Thus, it is possible to initiate stamping cycles of parts incorporating vibrations of the forming device 3, which is not allowed by any other type of electro-mechanical press to date, furthermore providing the possibility of adjusting the vibration frequencies and amplitudes.

The motor 41 preferably comprises two eccentric shafts 43d, 43g mounted on bearings, to each of which is coupled by a first ball joint (or any similar coupling) a first end of a connecting rod 44d, 44g, the second end of which is mounted by a second ball joint (or any similar coupling) on the forming device 3. Of course, as shown in the figures, the two eccentric axes 43d, 43g are such that they are exactly symmetrical to each other with respect to the median planes P2, P3 of press 1. Indeed, the slightest axial offset of the eccentrics in relation to these two planes can be critical to the operation of the press, in particular to the smooth guidance of the forming device and the integrity of the motor 41.

The use of a Torque motor 41 also has the advantage of offering great versatility in the configuration of actuator 4, particularly for varying the power. In particular, it is possible to combine a number of Torque motors 41 in series and to couple them axially in order to double the power of the press.

The forming device 3 is mounted so as to be movable in translation in the vertical plane P2 on or in relation to said work table 5. It advantageously comprises a gantry sliding by means of slides 8 on said table 5, said gantry comprising a crosspiece 31 for mounting a forming tool 35 by means of a tool holder 34, said crosspiece being integral at its respective ends, for example by welding or bolting, from a first end of a link arm 32d, 32g mounted rotatably at a second end by a 36d, 36g pin to one of said connecting rod 44d, 44g of the electromechanical actuating device 4 via a said second ball joint traversed by said 36d, 36g pin in a manner conventional for the man of the trade. The forming device 3 is thus driven in translation on table 5 in plane P2 by a connecting rod and crank system which is classic in the field of machining presses.

The guides 8 are preferably arranged on the arms 32d, 32g of the sliding portal frame on the one hand and in lateral guide openings 51 of the arms formed for this purpose in table 5 symmetrically to the plane P2. Advantageously, means for dynamic displacement and adjustment of the distance of the movable crosshead 31-working table 5 are provided on the forming device for the adjustment of the bottom dead centre and the absolute scale on the table as well as compensation of the expansion during the operation of the press.

Press 1 of the invention furthermore advantageously comprises a numerical control device, not shown in the figures. This NC control device, which is in itself well known to the tradesman in the field of machine tools and industrial automation, is preferably configured to electronically control actuating device 4 according to desired work cycles which are pre-programmed in the NC control or loaded into it via a company network. This enables the CNC control, for example, to infinitely adjust the feed parameters and speed of the Torque motor 41 to deliver a specific power output from the press. The CNC control can also advantageously control the linear motion motor assembly 6 before adjusting the height of the Torque motor 41 on frame 2 and thus the striking height of the forming tool 35 in relation to the plane P1 of the work table 5 as required.

If required, the CNC control can also be combined with auxiliary PLCs for loading press 1 and changing forming tool 35 on tool holder 35.

The operation of press 1 is in itself classic to that of a crank press, well known to the man of art. When the Torque motor 41 is switched on, the eccentrics 43d, 43g and the end of the connecting rod 42d, 42g coupled to it are rotated, which transmits to the forming device 3, which is guided in translation on the work table 5, a translational to-and-fro movement in plane P2 which drives the work tool 35 alternatively in plane P1 to perform a sample forming operation. For the purposes of the invention, a sample means any piece or slug of metallic raw material to be formed or preformed part to be reworked.

The location of the electromechanical actuating device under the work table 5 gives the press increased compactness and stability. In addition, the use of a Torque motor provides the advantage of an essentially electronic instantaneous motor control, which allows the motor's power consumption to be optimised according to the work carried out.

Finally, the proposed press structure can also be used for a horizontal press, in which the press frame 2 is rotated by 90°, as well as the actuating device 4 and the forming device 3. The vertical orientation of the torque motor 41 does not interfere with its operation and the linear slide guide of the forming device 3 on the work table 5 ensures in any case, with adequate lubrication, a good performance of the press even in an inclined position.

1. Electromechanical press (1) for forming workpieces by deforming and/or cutting material from a sample, comprising:
a work table (5) defining, in an orthonormal marker XYZ, an upper work plane P1, coinciding with the XZ plane of the marker, on which one or more samples to be formed can be arranged at one or more predetermined positions, and
a device for forming (3) workpieces by deforming and/or cutting material from said samples arranged on the working plane of said table (5), the device for forming (3) workpieces comprising a forming tool (35) arranged so as to be movable in translation in a plane P2 perpendicular and secant to the working plane P1 of the table, and
an electromechanical actuating device (4) for actuating the forming device (3), supported on a frame (2) which is fixed in position relative to the working plane P1, the electromechanical actuating device (4) being arranged in kinematic connection with the forming device (3) in order to move said forming tool (35) back and forth over a given stroke in the plane P2,
wherein the electromechanical actuating device (4) comprises at least one Torque-type electric motor (41) with an eccentric axis (43d, 43g) arranged in kinematic connection with the forming device (3), the electromechanical actuating device (4) being supported on the frame (2) in a position intersecting the plane P2 of movement of the forming device and located between a base (23) of the frame on the floor and the work table (5) under the work plane P1, while the forming tool (35) is held in any position in or above the work plane P1 of the work table (5), the work table being integral with the frame (2).

2. The electromechanical press (1) according to claim 1, wherein the electromechanical actuating device (4) comprises at least one connecting rod (44d, 44g) mounted in rotation at a first end on said eccentric shaft of the Torque motor (41) and at a second end on the forming device (3).

3. The electromechanical press (1) according to claim 1, wherein the frame (2) comprises partition walls (25) fixed integrally to the work table (5) and the anchoring base (23) in such a way that the electromechanical actuating device (4) is fitted to the frame.

4. The electromechanical press (1) according to claim 1, wherein the forming device (3) is mounted so as to be movable in translation in the plane P2 on said work table (5).

5. The electromechanical press (1) according to claim 2, wherein the electromechanical actuating device (4) comprises an electric motor (41) of the Torque-type provided with two opposite eccentric shafts (43d, 43g) each connected to a connecting rod (44d, 44g) mounted in rotation at a first end on said eccentric shaft (43d, 43g) of the Torque motor (41) and at a second end on the forming device (3).

6. The electromechanical press (1) according to claim 5, wherein the forming device (3) comprises a gantry sliding on said table (5), said gantry comprising a cross-member (31) for mounting the forming tool (35) integral at respective ends with a first end of a link arm (32d, 32g) mounted to rotate at a second end to a said connecting rod (44d, 44g) of the electromechanical actuating device (4).

7. The electromechanical press (1) according to claim 6, further comprising members (8) for guiding in translation, in particular of the slide type, the forming device (3) in the plane P2 on the work table (5).

8. The electromechanical press (1) according to claim 7, wherein the translation guide members (8) are arranged on the arms (32d, 32g) of the sliding gantry on the one hand and in lateral openings (51) for guiding said arms formed for this purpose in the table (5) symmetrically with respect to the plane P2.

9. The electromechanical press (1) according to claim 6, further comprising means for dynamically displacing and adjusting the distance of the movable crosshead (31) from the work table (5) in the plane P2

10. The electromechanical press (1) according to claim 1, wherein the electromechanical actuating device (4) is arranged displaceably along a V axis parallel to the Y axis relative to the work table (5) on the frame (2).

11. The electromechanical press (1) according to claim 10, wherein the actuating device (4) is slidably mounted on the frame (2) by means of complementary linear guide members (7) fixed on the actuating device (4) and the frame (2) and kinematically connected to a motor unit (6) for linear displacement in translation along the V axis relative to the work table (5).

12. The electromechanical press (1) according to claim 11, wherein the motor assembly (6) comprises a hydraulic jack or flywheel jack integral with a worm screw.

13. The electromechanical press (1) according to claim 11, further comprising a numerical control device for the actuating device (4).

14. The electromechanical press (1) according to claim 13, wherein the numerical control device is configured to drive the linear displacement motor assembly (6).

15. The electromechanical press (1) according to claim 1, wherein the actuating device (4) comprises a plurality of electric motors (41) of the Torque-type mounted electrically in series and kinematically coupled to one another at their respective drive shafts.

16. The electromechanical press (1) according to claim 2, wherein the frame (2) comprises partition walls (25) fixed integrally to the work table (5) and the anchoring base (23) in such a way that the electromechanical actuating device (4) is fitted to the frame.

17. The electromechanical press (1) according to claim 2, wherein the forming device (3) is mounted so as to be movable in translation in the plane P2 on said work table (5).

18. The electromechanical press (1) according to claim 3, wherein the forming device (3) is mounted so as to be movable in translation in the plane P2 on said work table (5).

19. The electromechanical press (1) according to claim 1, further comprising members (8) for guiding in translation, in particular of the slide type, the forming device (3) in the plane P2 on the work table (5).

20. The electromechanical press (1) according to claim 2, further comprising members (8) for guiding in translation, in particular of the slide type, the forming device (3) in the plane P2 on the work table (5).
